(19) United States
(12) Patent Application Publication
(10) Pub. No.: US 2007/0095433 A1
(43) Pub. Date: May 3, 2007

(54) METHOD AND APPARATUS FOR TREATING CRACKS IN SLABS

(75) Inventors: Marland R. Ottenbreit, Regina, SK (CA); Darrin A. Craig, Regina, SK (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: 6457061 CANADA LTD., Saskatoon (CA)

(21) Appl. No.: 11/553,938

(22) Filed: Oct. 27, 2006

(30) Foreign Application Priority Data
Oct. 27, 2005 (CA) 2522382

(51) Int. Cl. B23K 7/10

(52) U.S. Cl. 148/196; 148/200; 266/77

(57) ABSTRACT

A method for treating cracks in slabs involving a step of positioning at least one cutting torch along a slab processing line. The at least one cutting torch being positioned to cut a slab portion where cracking commonly occurs from the slab at it passes along the slab processing line.

### FIELD OF THE INVENTION

The present invention relates to a method of treating cracks in slabs during processing and, in particular, steel slabs.

### BACKGROUND OF THE INVENTION

In a steel mill, after a steel slab is cast, it must be cooled. As it cools, cracks appear on the slab. When rolling plate, these cracks tend to propagate into the finished plate creating defects. The current process for dealing with these cracks is to take the slabs off line and allow them to cool. A procedure known as “scarfing” is then used to remove the cracks.

### SUMMARY OF THE INVENTION

According to one aspect of the present invention there is provided a method for treating cracks in slabs, which involves a step of positioning at least one cutting torch along a slab processing line. The at least one cutting torch being positioned to cut a slab portion where cracking commonly occurs from the slab at it passes along the slab processing line.

According to another aspect of the present invention there is provided an apparatus for treating cracks in slabs, which includes a torch support with at least one torch mounted on the torch support. A tracking system is connected to the torch support, which is adapted to provide consistent vertical and horizontal positioning for the torch support relative to a slab moving along a slab processing line.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view taken from a downstream vantage point of an apparatus for treating cracks in slabs constructed in accordance with the teachings of the present invention.

FIG. 2 is a perspective view taken from an upstream vantage point of the apparatus for treating cracks in slabs illustrated in FIG. 1.

FIG. 3 is a perspective view taken from a side vantage point of the apparatus for treating cracks in slabs illustrated in FIG. 1.

FIG. 4 is an upstream elevation view of the apparatus for treating cracks in slabs illustrated in FIG. 1.

FIG. 5 is a top plan view of cutting torches from the apparatus for treating cracks in slabs illustrated in FIG. 1.

FIG. 6 is a side elevation view of cutting torches from the apparatus for treating cracks in slabs illustrated in FIG. 1.

FIG. 7 is a perspective view of cutting torches positioned along the top surface of slabs.

### DETAILED DESCRIPTION OF THE PREFERRED EMBODIMENT

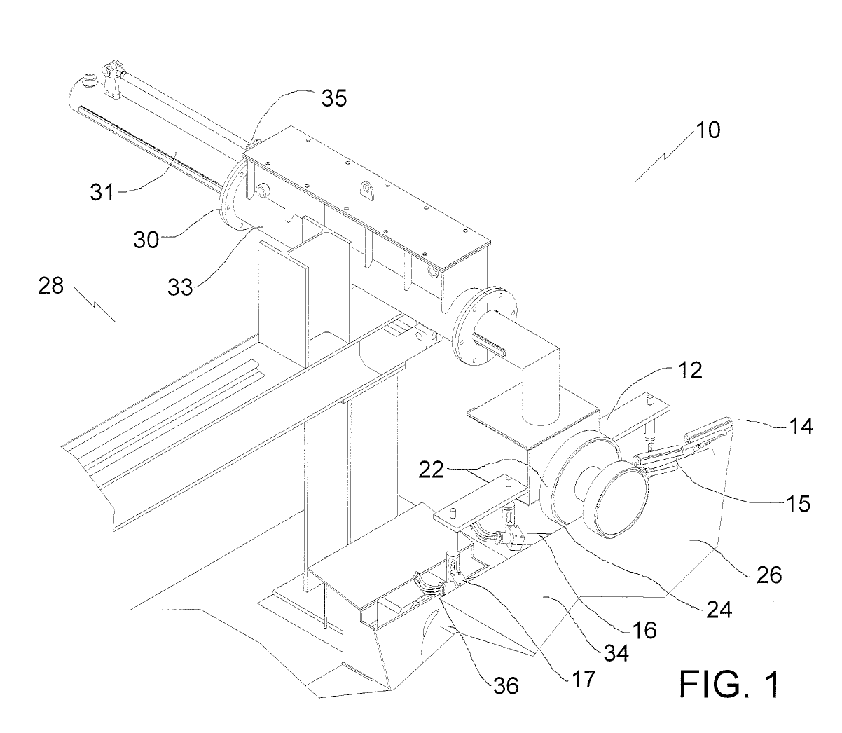

The preferred embodiment, an apparatus for treating cracks in slabs generally identified by reference numeral 10, will now be described with reference to FIGS. 1 through 6.

Structure and Relationship of Parts:

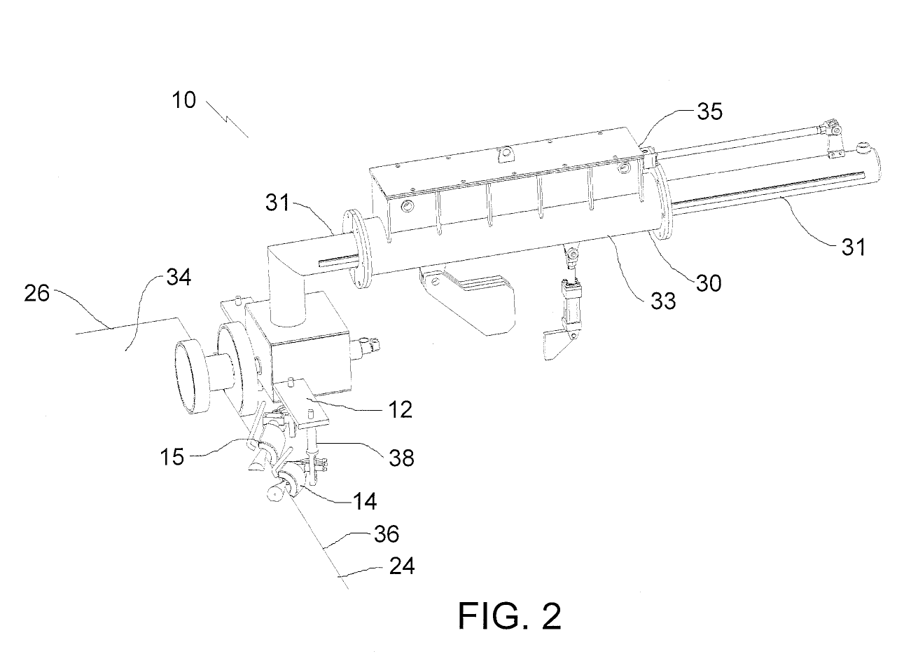

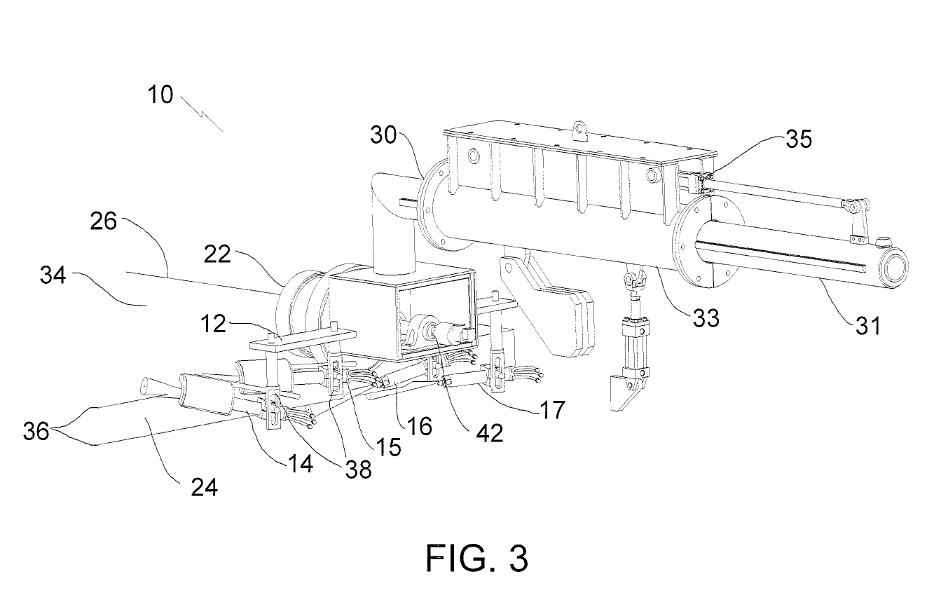

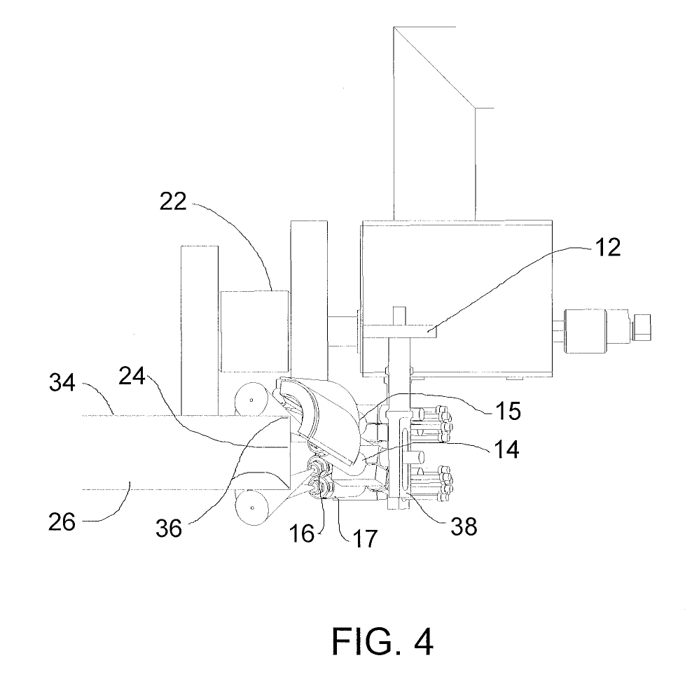

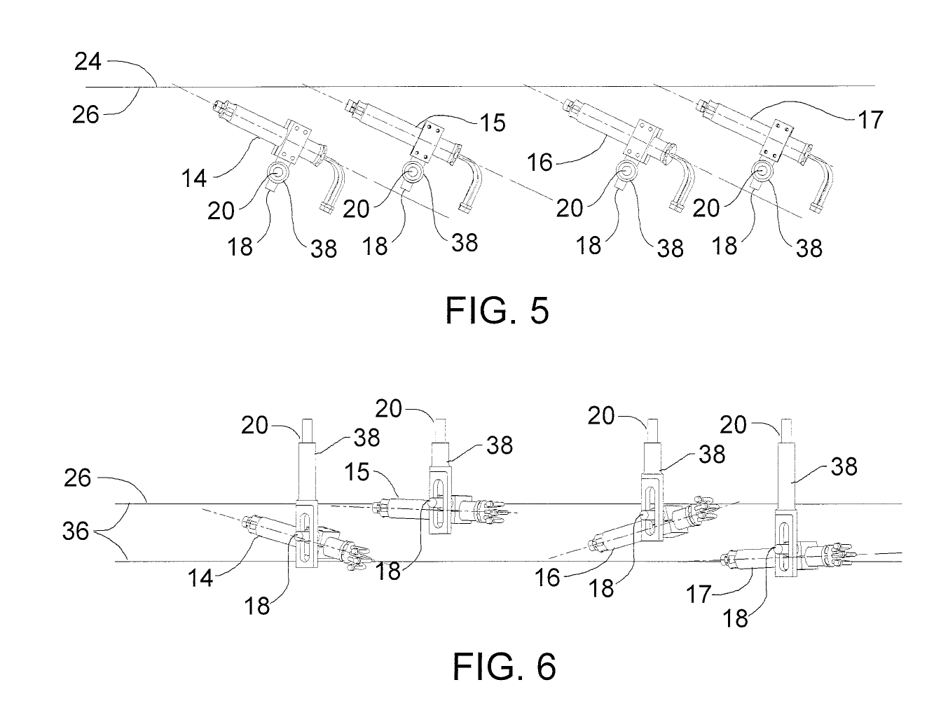

Referring to FIG. 1, apparatus 10 includes a movable torch support 12. Referring to FIG. 4, two pairs of cutting torches are mounted on torch support 12. Each pair has a leading torch 14 and 15 and a trailing torch 16 and 17, respectively. It will be understood that different numbers of torches may be present, such as only one pair of torches, or four pairs, one for each corner 36 of a slab 26. Referring to FIGS. 5 and 6, each cutting torch 14, 15, 16, and 17 is pivotally mounted on torch support 12 for pivotal movement about a horizontal pivot axis 18 and about a vertical pivot axis 20. Referring to FIG. 2, there is a tracking system in the form of a flanged roller 22 connected to torch support 12. Flanged roller 22, which is water cooled stainless steel, tracks the edge 24 of a slab 26 moving along a slab processing line 28 to provide consistent vertical and horizontal positioning for torch support 12 relative to slab 26. Referring to FIG. 3, torch support 12 is carried by a telescopic cylinder 30 which is adapted to move torch support 12 toward and away from slab processing line 28, thereby providing lateral adjustment to smit the width of slab 26. An inner tube 31 slides inside an outer tube 33 and is actuated by a hydraulic cylinder 35 to accomplish this. Inner tube 31 is water-cooled and acts as a water supply manifold for torches 14, 15, 16 and 17. Hydraulic cylinder 35 has a linear transducer mounted internally (not shown) to provide position feedback. The PLC can then be programmed for various widths of slabs and the system can automatically adjust to pre programmed slab widths. As leading torches 14 and 15 and trailing torches 16 and 17 are each independently operable, only leading torches 14 and 15 need be activated when only small cracks arc present. It is preferred that a pneumatic nozzle (not shown) be directed at slab 26 and adapted to blow excess slag created during the scarfing operation from the surface 34 of slab 26.

Operation:

Referring now to FIGS. 1 through 6, apparatus 10 is provided as described above. Referring to FIG. 1, the method of using apparatus 10 to treat cracks in slabs 26 begins by positioning cutting torches 14, 15, 16 and 17 along slab processing line 28. It is preferred that these cutting torches be positioned along the caster runout table. Referring to FIG. 4, cutting torches 14, 15, 16, and 17 are positioned to cut a corner 36 from slab 26 where cracking commonly occurs at it passes along slab processing line 28. They are arranged in pairs including a leading torch 14 and 15 and a trailing torch 16 and 17 mounted with each pair cutting a different corner 36 of slab 26. There may be one pair, two pairs, or a pair for each corner. The cutting speed of scarfing torches 14, 15, 16, and 17 is adjusted to suit the speed of slab processing line 28. For example, the speed at which the system makes the cut varies front 1″ per minute to 65″ per minute or faster. The torches can be adjusted to match the speed of the casting operation. Suitable cutting torches to use as torches 14, 15, 16, and 17 are as oxygen/natural gas torches such as Oxy-Arc brand, OXY2 Series, P/N OXY2AW with a 2″ body and 10″ barrel and Oxy-Arc CC130 cutting tips. These torches are water cooled with a stainless steel body. Potentially the same results can be achieved by other methods of cutting such as Plasma Arc or laser.

Referring to FIGS. 5 and 6, leading torch 14 and trailing torch 16 are able to pivot upwardly or downwardly about a horizontal pivot axis 18 at an angle within an approximate range of angles between 0 degrees and 35 degrees, and pivoted inwardly or outwardly about a vertical pivot axis 20 toward the slab within a preferred range of angles of 15 degrees and 35 degrees. These parameters apply to each pair of torches present. The torches 14 and 16 are placed at an angle measured from horizontal surface 34 of slab 26 vertically down and from edge 24 of slab 26 measured horizontally out. The torches work in a range of angles depending upon the speed of the casting operation and the temperate of the slab. Fine adjustments can be made to the angles to obtain the optimum cut. Brackets 38 that holds the torches allow for vertical, angular, and rotational adjustment. In a preferred position, leading torch 14 is pivoted upwardly about horizontal pivot axis 18 at an angle of approximately 15 degrees and pivoted about vertical pivot axis 20 inwardly toward slab 26 at an angle of approximately 25 degrees, while trailing torch 16 is pivoted about horizontal pivot axis 18 upwardly at an angle of approximately 2 degrees, and pivoted about vertical pivot axis 20 inwardly toward slab 26 at an angle of approximately 25 degrees. However, there will be a range of angles that torches 14 and 16 will perform adequately and these angles can be fine-tuned.

An approximate 4″ stand-off distance between the cutting torch tip and the slab is the optimal distance to produce the desired cut quality. Also the center oxygen stream from the torch, which is approximately ⅜″ in diameter is preferably directed at the corner of the slab with 75% of the stream being below the corner of the slab.

By way of a qualitative discussion, the angles can be seen in FIG. 4, which shows torches 14 and 16 mounted in brackets 38 that position them so that the cutting stream is a steep angle against the direction of travel of slab 26. This enables torches 14 and 16 to maintain a puddle and the cut. Lead torch 14 typically produces a 45 degree chamfer on corner 36 of slab 26. The amount of material removed can be adjusted depending upon the depth of the cracks that need to be removed. The torch angle or stand-off distance to slab 26 can be adjusted to accommodate any size of crack, as discussed above. Trailing torch 16 is laid at a very slight angle from horizontal, and a steep angle against the direction of travel of slab 26, so that it skims off a wedge shaped portion of slab 26 to remove any cracks that have propagated into the material beyond corner 36 that was removed by lead torch 14. As mentioned above, pairs of torches can be placed at all four corners 36 of slab 26 to remove cracks on all four corners.

Apparatus 10 is also designed so that the depth of the cut can be adjusted. The depth and length of the cracks to be removed may vary depending on the type of material, casting process, and any cooling or quenching process. Thus, the adjustment system allows torches 14, 15, 16, and 17 to be positioned at varying heights to increase or decrease the amount of material removed. With a two-torch system, leading torch 14 is used to cut off corner 36 of slab 26 at 45°. The amount of corner 36 cut off can be adjusted from ¼″ to 1″ or larger. Trailing torch 16 follows lead torch 14 and is used to cut surface 34 of slab 26 from corner 36 in towards the center 40 of slab 26. The thickness of material removed and the length of material removed from the edge of slab 26 towards center 40 can also be adjusted to remove different crack lengths and depths. The amount typically removed is from ⅛″ to ⅜″ thick and 2″ to 4″ in length measured from corner 36 of slab 26 towards center 40.

In order to maintain a consistent cutting depth, a horizontal and vertical tracking system adjusts torches 14, 15, 16 and 17 as slab 26 passes through slab processing line 28. The system consists of fanged rollers 22, mounted on pivot points 42, that keep a constant pressure against corner 36 of slab 26. Torch holders 14 are mounted to rollers 22 so that as slab edge 24 moves up and down, torches 14, 15, 16 and 17 track slab 26. This ensures a consistent thickness of cut in both directions. The system also adjusts to various slab widths by sliding torch supports 12 in and out. Inner tube 31 slides inside outer tube 33 and is actuated by hydraulic cylinder 35 to accomplish this. It will be appreciated that there are other means of accomplishing this horizontal and vertical tracking. For example, an electronic system could be employed using proximity sensors.

The torches are positioned to remove the corners of the slab because this is generally where the cracks originate. The system is designed so that the cutting of each corner can be controlled independently. In some instances cracking may occur on the top of the slab and not the bottom thus the top cutting can be operated with the bottom turned off.

Depending upon the material being produced and the cracks that develop, the system can run with a pair of torches 14 and 16 operating at the same time, or with one of the pair operating independently. If there were a pair for each corner of slab 26, a total of eight torches could be running simultaneously. If the product being produced needs only the corner cut off, the lead torch of each pair can be operated by its self, or conversely, if the precuts requires only the surface to be removed, the trailing torch of each pair can be operated without the lead torch. Thus, depending upon the cracks in the product, the cut profile can be adjusted to accommodate.

It will be appreciated that for minor cracks, the “cutting” by the cutting torches can merely involve melting the material to remove cracks.

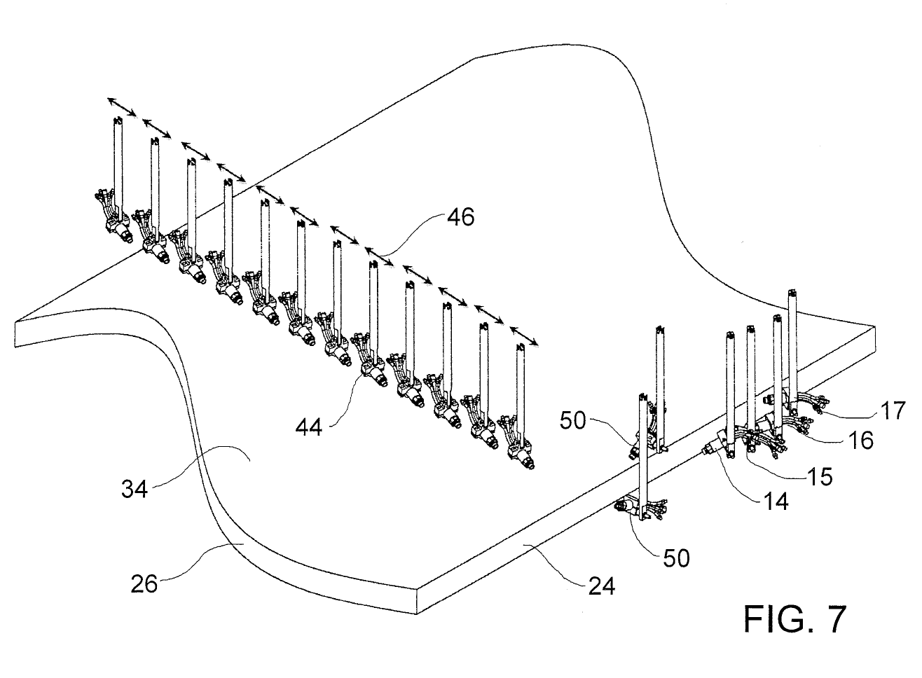

Referring to FIG. 7, when treating cracks on surface 34 of slab 26 cutting torches 44 are positioned to scarf along surface 34 of slab 26. In some circumstances, it may be preferable to have cutting torches 44 oscillate, as represented by arrows 46, representing movement perpendicular to the movement of slab 26. When cutting torches 44 oscillate, they can cover more of surface 34 in order to keep pace with the movement of slab 26, while cutting less material off surface 34. Cutting torches 44 are also capable of rotation as with the torches previously described. Other features described above may also be used with cutting torches 44 where practical. FIG. 7 also shows two additional torches 50 for concurrently scarfing corners along edge 24.

Advantages:

The above described method that enables scarfing “on line” as the slab exits the caster onto the caster runout table substantially reduces steel plate production costs. There is no longer a need to cool the slab enough to allow workers to manually scarf the corners and then waste energy re-heating the slab to the rolling temperature. There are no longer labour costs incurred in handling the slabs to take them off line, manually scarfing the slab and then return them to the line. In cases where the slab must be removed from the line, the scarfing may occur before removal or after. For example, the slab temperature may vary from ambient temperature to 2100° F. Thus the apparatus can be used on line while the steel is being produced or off line if the slabs have cooled. Although the present invention was developed to meet the particular needs of the steel industry, its teachings will be equally applicable to other metal materials that are formed into slabs prior to being further processed.

Although major advantages are to be obtained by integrating the method and apparatus into a steel making process that involves the formation of the steel slab, it will be appreciated that steel rolling plants that acquire their slabs from elsewhere can still obtain advantages by including the method and apparatus in their slab processing line.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method for treating cracks in slabs, comprising the step of:
positioning at least one cutting torch along a slab processing line, the at least one cutting torch being positioned to cut a slab portion where cracking commonly occurs from the slab at it passes along the slab processing line.

2. The method as defined in claim 1, a cutting speed of the at least one cutting torch being adjusted to suit a speed of the slab processing line.

3. The method as defined in claim 1, the slab portion being a corner.

4. The method as defined in claim 1, the slab portion being a surface of the slab.

5. The method as defined in claim 1, there being more than one cutting torch.

6. The method as defined in claim 4, there being more than one cutting torch arranged along the surface of the slab.

7. The method as defined in claim 6, the more than one cutting torch oscillating such that less of the slab portion is cut by the cutting torch.

8. The method as defined in claim 3, there being more than one cutting torch, the more than one cutting torch being arranged in pairs, with each pair cutting one corner of the slab.

9. The method as defined in claim 8, the pair of torches including a leading torch and a trailing torch mounted on a torch support.

10. The method as defined in claim 9, the leading torch being pivoted about a horizontal pivot axis upwardly at an angle within a preferred range of angles between 0 degrees and 35 degrees and pivoted about a vertical pivot axis inwardly toward the slab within a preferred range of angles of 15 degrees and 35 degrees.

11. The method as defined in claim 9, the trailing torch being pivoted about a horizontal pivot axis upwardly at an angle within a preferred range of angles between 0 degrees 35 degrees and pivoted about a vertical pivot axis inwardly toward the slab within a preferred range of angles of 15 degrees and 35 degrees.

12. The method as defined in claim 9, the leading torch being pivoted about a horizontal pivot axis upwardly at all angle of approximately 15 degrees and pivoted about a vertical pivot axis inwardly toward the slab at an angle of approximately 25 degrees.

13. The method as defined in claim 9, the trailing torch being pivoted about a horizontal pivot axis upwardly at an angle of approximately 2 degrees and pivoted about a vertical pivot axis inwardly toward the slab at an angle of approximately 25 degrees.

14. A method for treating cracks in slabs, comprising the step of:
positioning more than one cutting torch along a slab processing line, the more than one scarfing torch being positioned to cut a corner where cracking commonly occurs from the slab at it passes along the slab processing line, a cutting speed of the more than one cutting torch being adjusted to suit a speed of the slab processing line, the more than one cutting torch being arranged in pairs including a leading torch and a trailing torch mounted, with each pair cutting one corner of the slab.

15. The method as defined in claim 14, the leading torch being pivoted about a horizontal pivot axis upwardly at an angle within a preferred range of angles between 0 degrees and 35 degrees and pivoted about a vertical pivot axis inwardly toward the slab within a preferred range of angles of 15 degrees and 35 degrees.

16. The method as defined in claim 14, the trailing torch being pivoted about a horizontal pivot axis upwardly at an angle within a preferred range of angles between 0 degrees and 35 degrees and pivoted about a vertical pivot axis inwardly toward the slab within a preferred range of angles of 15 degrees and 35 degrees.

17. The method as defined in claim 14, the leading torch being pivoted about a horizontal pivot axis upwardly at an angle of approximately 15 degrees and pivoted about a vertical pivot axis inwardly toward the slab at an angle of approximately 25 degrees.

18. The method as defined in claim 14, the trailing torch being pivoted about a horizontal pivot axis upwardly at an angle of approximately 2 degrees and pivoted about a vertical pivot axis inwardly toward the slab at an angle of approximately 25 degrees.

19. An Apparatus for treating cracks in slabs, comprising:
a torch support;
at least one torch mounted on the torch support;
a tracking system is connected to the torch support, the tracking system being adapted to provide consistent vertical and horizontal positioning for the torch support relative to a slab moving along a slab processing line.

20. The apparatus as defined in claim 19, wherein the at least one torch is pivotally mounted on the torch support for pivotal movement about a horizontal pivot axis and about a vertical pivot axis.

21. The apparatus as defined in claim 19, wherein the tracking system includes at least one flanged roller that tracks along an edge of the slab.

22. The apparatus as defined in claim 21, wherein the flanged roller is water cooled.

23. The apparatus as defined in claim 19, wherein the torch support is carried by a telescopic cylinder which is adapted to move the torch support toward and away from the slab processing line, thereby providing lateral adjustment to suit a width of the slab.

24. The apparatus as defined in claim 19, wherein there is more than one cutting torch on the torch support.

25. The apparatus as defined in claim 24, wherein means are provided for oscillating the more than one cutting torch positioned along the surface of the slab

26. The apparatus as defined in claim 24, wherein the more than one cutting torch are arranged in pairs, with each pair cutting one corner of the slab.

27. The apparatus as defined in claim 26, wherein the pair of torches include a leading torch and a trailing torch mounted on a torch support.

28. The apparatus as defined in claim 27, wherein the leading torch and the trailing torch are independently operable, such that only the leading torch need be activated for small cracks.

29. The apparatus as defined in claim 24, wherein the torch support supports a pair of torches aimed at an upper corner of the slab and a pair of torches aimed at a lower corner of the slab.

30. The apparatus as defined in claim 19, wherein at least one pneumatic nozzle is directed at the slab, the nozzle being adapted to blow excess slag created during the scarfing operation from a surface of the slab.

31. The apparatus as defined in claim 19, wherein the at least one torch is a gas torch.

32. An apparatus for treating cracks in slabs, comprising:
a movable torch support;
more than one cutting torch mounted on the torch support including a leading torch and a trailing torch, each scarfing torch being pivotally mounted on the torch support for pivotal movement about a horizontal pivot axis and about a vertical pivot axis; and
a tracking system in the form of a flanged roller connected to the torch support, the flanged roller tracking an edge of a slab moving along a slab processing line to provide consistent vertical and horizontal positioning for the torch support relative to a slab moving along a slab processing line.

33. The apparatus as defined in claim 32, wherein the flanged roller is water cooled.

34. The apparatus as defined in claim 32, wherein the torch support is carried by a telescopic cylinder which is adapted to move the torch support toward and away from the slab processing line, thereby providing lateral adjtustiiien-t to suit a width of the slab.

35. The apparatus as defined in claim 32, wherein the leading torch and the trailing torch are independently operable, such that only the leading torch need be activated for small cracks.

36. The apparatus as defined in claim 32, wherein the torch support supports an upper pair of torches aimed at an upper corner of the slab and a lower pair of torches aimed at a lower corner of the slab.

37. The apparatus as defined in claim 32, wherein at least one pneumatic nozzle is directed at the slab, the nozzle being adapted to blow excess slag created during the scarfing operation from a surface of the slab.

38. The apparatus as defined in claim 32, wherein the at least one torch is a gas torch.
